(19) United States
(12) Patent Application Publication
(10) Pub. No.: US 2018/0189883 A1
(43) Pub. Date: Jul. 5, 2018

(54) Earth Invest Score for Stock Prices

(71) Applicant: Cyrus Afshar, Washington, DC (US)

(72) Inventor: Cyrus Afshar, Washington, DC (US)

(21) Appl. No.: 15/396,364

(22) Filed: Dec. 30, 2016

(51) Int. Cl. G06Q 40/06

(52) U.S. Cl. CPC G06Q 40/06

(57) ABSTRACT

A method for determining whether a stock price (or a stock price index or stock price indices) are more likely to rise or fall. A plurality of factor scores, based on a plurality of factors, is determined. An aggregate score, based on a plurality of factor scores, is then determined.

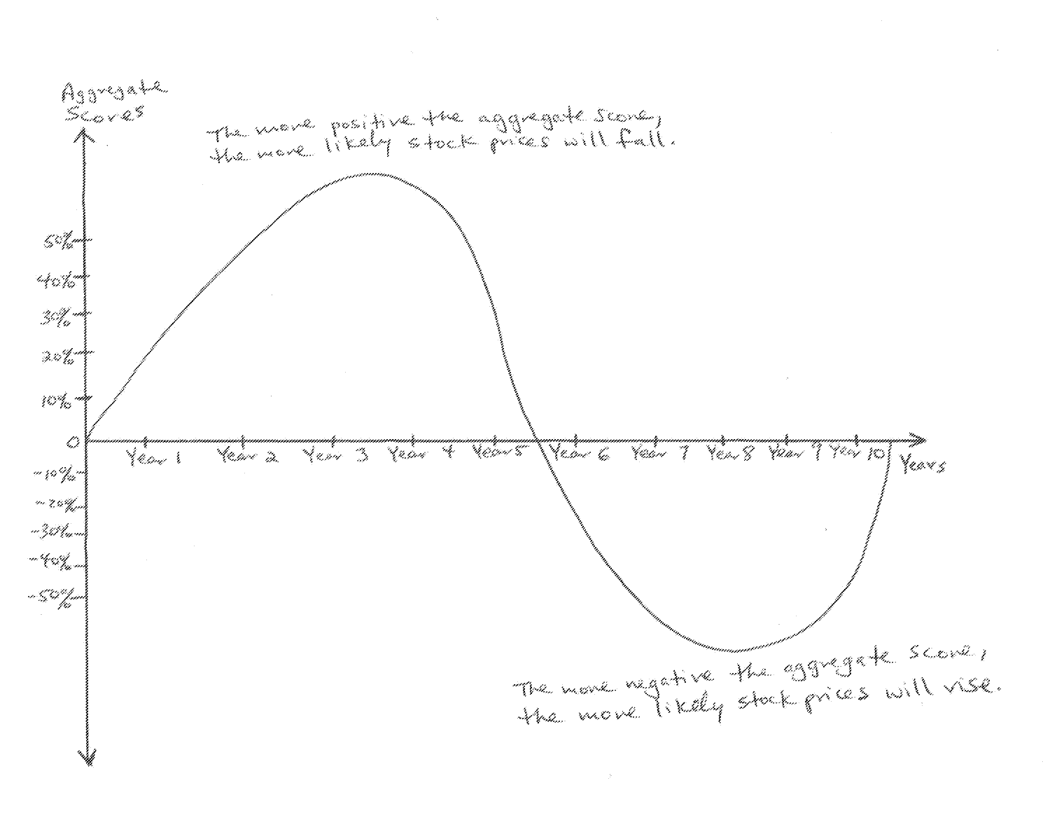

### CROSS-REFERENCE TO RELATED APPLICATIONS

This application claims the benefit of U.S. Provisional Patent Application No. 62/274,153, entitled “Earth Invest Score for Stock Prices,” filed on Dec. 31, 2015.

### BACKGROUND OF THE INVENTION

This invention pertains to investing and most likely belongs in one of the three patent classifications below:

1. Class 705, Subclass 35;

2. Class 705, Subclass 36; or

3. Class 705, Subclass 37.

### BRIEF SUMMARY OF THE INVENTION

Almost all news sources for stock prices (or a stock price index or stock price indices) describe what has already occurred in the market. For example, they'll describe stock price changes that occurred over the previous day or month or quarter or year. These after-the-fact descriptions are not very useful.

The purpose of this invention is to create an aggregate score of useful forward-looking stock prices information.

This invention uses time-tested value investing principles to help identify whether stock prices are more likely to rise or fall. Value investing is based on the notion that there is a long term fundamental value for every investment. In the short term, the market overreacts to good news and bad news, but in the long term, every investment returns to its fundamental value.

This invention helps to identify the long term fundamental value of stock prices by using ratios of key market variables. This invention compares the current values of these ratios to their historic averages to help identify whether stock prices are more likely to rise or fall.

### BRIEF DESCRIPTION OF THE SINGLE VIEW OF THE DRAWING

The drawing portrays exemplary embodiment #1, from the Detailed Description of the Invention, in a graphical form.

The more positive the aggregate score, the more likely stock prices will fall.

The more negative the aggregate score, the more likely stock prices will rise.

### DETAILED DESCRIPTION OF THE INVENTION

Various embodiments of this invention are described below to:

(a) Determine a plurality of factor scores, based on a plurality of factors; and

(b) Determine an aggregate score, based on a plurality of factor scores.

1. In one exemplary embodiment, the following steps are taken:

Step 1: Current Values

(a) Calculate (Stock Price)÷(Company Sales);

(b) Calculate (Stock Price)÷(Company Earnings); and

(c) Calculate (Stock Price)÷(Company Book Value).

Step 2: Historic Values

(a) Calculate the 5-year trailing average (or 5-year projected average or a hybrid of trailing and projected average) of (Stock Price)÷(Company Sales);

(b) Calculate the 5-year trailing average (or 5-year projected average or a hybrid of trailing and projected average) of (Stock Price)÷(Company Earnings); and

(c) Calculate the 5-year trailing average (or 5-year projected average or a hybrid of trailing and projected average) of (Stock Price)÷(Company Book Value).

Step 3: Historic Values

(a) Calculate the 10-year trailing average (or 10-year projected average or a hybrid of trailing and projected average) of (Stock Price)÷(Company Sales);

(b) Calculate the 10-year trailing average (or 10-year projected average or a hybrid of trailing and projected average) of (Stock Price)÷(Company Earnings); and

(c) Calculate the 10-year trailing average (or 10-year projected average or a hybrid of trailing and projected average) of (Stock Price)÷(Company Book Value).

Step 4: Factor Scores

(a) Calculate the percentage difference between Step 1 (a) and Step 2 (a).
The percentage difference=(Stock Price)÷(Company Sales) compared to 5-year average factor score;

(b) Calculate the percentage difference between Step 1 (b) and Step 2 (b).
The percentage difference=(Stock Price)÷(Company Earnings) compared to 5-year average factor score; and

(c) Calculate the percentage difference between Step 1 (c) and Step 2 (c).
The percentage difference=(Stock Price)÷(Company Book Value) compared to 5-year average factor score.

Step 5: Factor Scores

(a) Calculate the percentage difference between Step 1 (a) and Step 3 (a).
The percentage difference=(Stock Price)÷(Company Sales) compared to 10-year average factor score;

(b) Calculate the percentage difference between Step 1 (b) and Step 3 (b).
The percentage difference=(Stock Price)÷(Company Earnings) compared to 10-year average factor score; and

(c) Calculate the percentage difference between Step 1 (c) and Step 3 (c).
The percentage difference=(Stock Price)÷(Company Book Value) compared to 10-year average factor score.

Step 6: Aggregate Score

(a) Calculate the average of Step 4 (a), Step 4 (b), Step 4 (c), Step 5 (a), Step 5 (b), and Step 5 (c).
The average of the factor scores=the aggregate score.
The more positive the aggregate score, the more likely stock prices will fall.
The more negative the aggregate score, the more likely stock prices will rise.

2. Alternative embodiments to exemplary embodiment #1 include, instead of using 5-year and 10-year trailing averages (or projected averages or a hybrid of trailing and projected averages), using 1-year, 2-year, 3-year, 4-year, 5-year, 6-year, 7-year, 8-year, 9-year, 10-year, 11-year, 12-year, 13-year, 14-year, 15-year, 16-year, 17-year, 18-year, 19-year, 20-year, 21-year, 22-year, 23-year, 24-year, 25-year, 26-year, 27-year, 28-year, 29-year, 30-year, 31-year, 32-year, 33-year, 34-year, 35-year, 36-year, 37-year, 38-year, 39-year, 40-year, 41-year, 42-year, 43-year, 44-year, 45-year, 46-year, 47-year, 48-year, 49-year, 50-year, 51-year, 52-year, 53-year, 54-year, 55-year, 56-year, 57-year, 58-year, 59-year, 60-year, 61-year, 62-year, 63-year, 64-year, 65-year, 66-year, 67-year, 68-year, 69-year, 70-year, 71-year, 72-year, 73-year, 74-year, 75-year, 76-year, 77-year, 78-year, 79-year, 80-year, 81-year, 82-year, 83-year, 84-year, 85-year, 86-year, 87-year, 88-year, 89-year, 90-year, 91-year, 92-year, 93-year, 94-year, 95-year, 96-year, 97-year, 98-year, 99-year, or 100-year trailing averages (or projected averages or a hybrid of trailing and projected averages).

3. Alternative embodiments to exemplary embodiments #1 or #2 include, instead of calculating the average (or mean), calculating the median, mode, variance, or standard deviation.

4. Alternative embodiments to exemplary embodiments #1, #2, or #3 include, instead of calculating the average (or mean), median, mode, variance, or standard deviation, calculating the weighted average (or mean), weighted median, weighted mode, weighted variance, or weighted standard deviation.

While various embodiments of this invention have been described above, it should be understood that they have been presented by way of example only, and not limitation. Thus, the breadth and scope of this invention should not be limited by any of the above-described embodiments.

What is claimed is:

1. A method for determining whether a stock price (or a stock price index or stock price indices) is more likely to rise or fall, comprising:
(a) Determining a plurality of factor scores, based on a plurality of factors; and
(b) Determining an aggregate score, based on a plurality of factor scores.

2. The method of claim 1, wherein determining a plurality of factor scores comprises an algorithm.

3. The method of claim 1, wherein determining an aggregate score comprises another algorithm.

4. The method of claim 1, wherein based on a plurality of factors comprises:
(a) Stock price (or a stock price index or stock price indices) for a given period of time;
(b) Company sales (or stock price index sales or stock price indices sales) for a given period of time;
(c) Company earnings (or stock price index earnings or stock price indices earnings) for a given period of time; and
(d) Company book value (or stock price index book value or stock price indices book value) for a given period of time.

5. The method of claim 1, wherein based on a plurality of factor scores comprises:
The current values and historical values of the ratios below:
(a) (Stock Price)÷(Company Sales);
(b) (Stock Price)÷(Company Earnings); and
(c) (Stock Price)÷(Company Book Value).

6. The method of claim 2, wherein an algorithm comprises:
Comparing the current values to the historic values of the ratios below:
(a) (Stock Price)÷(Company Sales);
(b) (Stock Price)÷(Company Earnings); and
(c) (Stock Price)÷(Company Book Value).

7. The method of claim 3, wherein another algorithm comprises:
Aggregating the comparisons of the current values to the historic values of the ratios below into an aggregate score:
(a) (Stock Price)÷(Company Sales);
(b) (Stock Price)÷(Company Earnings); and
(c) (Stock Price)÷(Company Book Value).

8. The method of claim 4, wherein a stock price (or a stock price index or stock price indices) comprises a measure of the market value of a share of stock for a given company (or a stock price index or stock price indices) for a given period of time and is often expressed as price per unit of stock or price per unit of common stock.

9. The method of claim 4, wherein company sales (or stock price index sales or stock price indices sales) comprises a measure of the total sales for a company (or a stock price index or stock price indices) for a given period of time and is often expressed as:
(a) Company sales over the trailing month or quarter or year, or as projected company sales, or as a hybrid of trailing and projected company sales; or
(b) Sales, net sales, revenue, or net revenue.

10. The method of claim 4, wherein company earnings (or stock price index earnings or stock price indices earnings) comprises a measure of the total earnings for a company (or a stock price index or stock price indices) for a given period of time and is often expressed as:
(a) Company earnings over the trailing month or quarter or year, or as projected company earnings, or as a hybrid of trailing and projected company earnings; or
(b) Net income, net income attributable to the company, net income attributable to common stockholders, or net income attributable to common shareholders.

11. The method of claim 4, wherein company book value (or stock price index book value or stock price indices book value) comprises a measure of the book value of a company (or a stock price index or stock price indices) for a given period time and is often expressed as:
(a) Company book value for the trailing month or quarter or year, or as projected company book value, or as a hybrid of trailing and projected company book value; or
(b) Stockholder's equity, shareholder's equity, stockholder's equity attributable to the company, shareholder's equity attributable to the company, stockholder's equity attributable to common stockholders, or shareholder's equity attributable to common shareholders.
